(19) United States
(12) Patent Application Publication
(10) Pub. No.: US 2007/0043871 A1
(43) Pub. Date: Feb. 22, 2007

(54) Debug non-terminal symbol for parser error handling

(75) Inventors: Jonathan Sweedler, Los Gatos, CA (US); Rajesh Nair, Fremont, CA (US); Komal Rathi, Sunnyvale, CA (US); Kevin J. Rowett, Cupertino, CA (US)

Correspondence Address: MARGER JOHNSON & MCCOLLOM, P.C., 210 SW MORRISON STREET, SUITE 400, PORTLAND, OR, 97204, US

(73) Assignee: Mistletoe Technologies, Inc., Cupertino, CA (US)

(21) Appl. No.: 11/185,223

(22) Filed: Jul. 19, 2005

(51) Int. Cl. G06F 15/16

(52) U.S. Cl. 709/227

(57) ABSTRACT

A device has an input port to allow the device to receive data. The device also has a parser to parse the data in response to symbols in a parser stack, determine when a symbol is a debug non-terminal symbol, and notify the device via an interrupt. The interrupt causes the device to gather information about the state of the parser at the time of encountering the non-terminal symbol.

### REFERENCE TO RELATED APPLICATIONS

Copending U.S. patent application Ser. No. 10/351,030, titled “Reconfigurable Semantic Processor,” filed by Somsubhra Sikdar on Jan. 24, 2003, is incorporated herein by reference.

### BACKGROUND

Packetization of data originally gained acceptance in network communications, providing a way to group data into chunks for transmission to allow for error recovery and to reduce the impact of the loss of a packet on an overall message. Packets are now used in many different kinds of communications, including within individual computers, such as data sent across a backplane of a computer.

Typically, packet headers and their functions are arranged at least partially according to the open-systems interconnection (OSI) reference model. This model partitions packet communications functions into layers where each layer performs specific functions that can be independent of the other layers. These layers are physical layer 1, data link layer 2, network layer 3, transport layer 4, session layer 5, presentation layer 6 and the application layer 7. Not all layers may be used, but each layer can add its own header to a packet, and may regard all higher-layer headers as merely part of the payload data to be transmitted.

Not all packets follow the basic pattern of cascaded headers with a simple payload. Packets may undergo IP fragmentation during transmission and may arrive at a receiver out-of-order. Some protocols allow aggregation of multiple headers/data payloads in a single packet and across multiple packets. Since packets are used to transmit secure data over a link, many packets are encrypted before they are sent, which causes some headers to be encrypted as well. Since these multi-layer packets have a large number of variations, programmable computers typically ensure that packet processing is performed accurately and effectively.

Traditional programmable computers use a von Neumann, or VN, architecture. The VN architecture, in its simplest form, comprises a central processing unit (CPU) and attached memory, usually with some form of input/output to allow useful operations. The VN architecture is attractive, as compared to gate logic, because it can be made “general-purpose” and can be reconfigured relatively quickly; by merely loading a new set of program instructions, the function of a VN machine can be altered to perform even very complex functions, given enough time. The tradeoffs for the flexibility of the VN architecture are complexity and inefficiency. Thus the ability to do almost anything comes at the cost of being able to do a few simple things efficiently.

In contrast, it is possible to implement a ‘semantic’ processing architecture, where the processor(s) respond directly to the semantics of an input stream. The execution of instructions is selected by the input stream. This allows for fast and efficient processing. This is especially true when processing packets of data.

### DESCRIPTION OF THE DRAWINGS

Embodiments of the invention may be best understood by reading the disclosure with reference to the drawings.

FIG. 1 shows an embodiment of a semantic processor in block form.

FIG. 2 shows an embodiment of a parser table.

FIG. 3 shows an embodiment of a production rule table organization.

FIG. 4 shows an embodiment of a parser in block form.

FIG. 5 shows a flow chart of an embodiment of processing data.

FIG. 6 shows a flow chart of an embodiment of processing a debug production rule in a semantic processor.

### DETAILED DESCRIPTION

Many devices communicate, either over networks or back planes, by broadcast or point-to-point, using bundles of data called packets. Packets have headers that provide information about the nature of the data inside the packet, as well as the data itself, usually in a segment of the packet referred to as the payload. Semantic processing, where the semantics of the header drive the processing of the payload as necessary, fits especially well in packet processing.

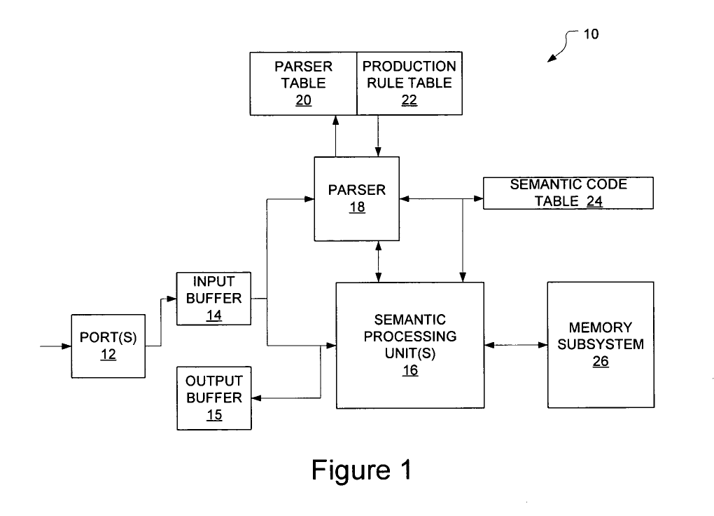

FIG. 1 shows a block diagram of a semantic processor 10. The semantic processor 10 may contain an input buffer 14 to buffer an input data stream received through the input port 12; a parser 18, which may also be referred to as a direct execution parser to control the processing of packets in the input buffer 12; at least one semantic processing unit 16 to process segments of the packets or to perform other operations; and a memory subsystem 26 to store or augment segments of the packets.

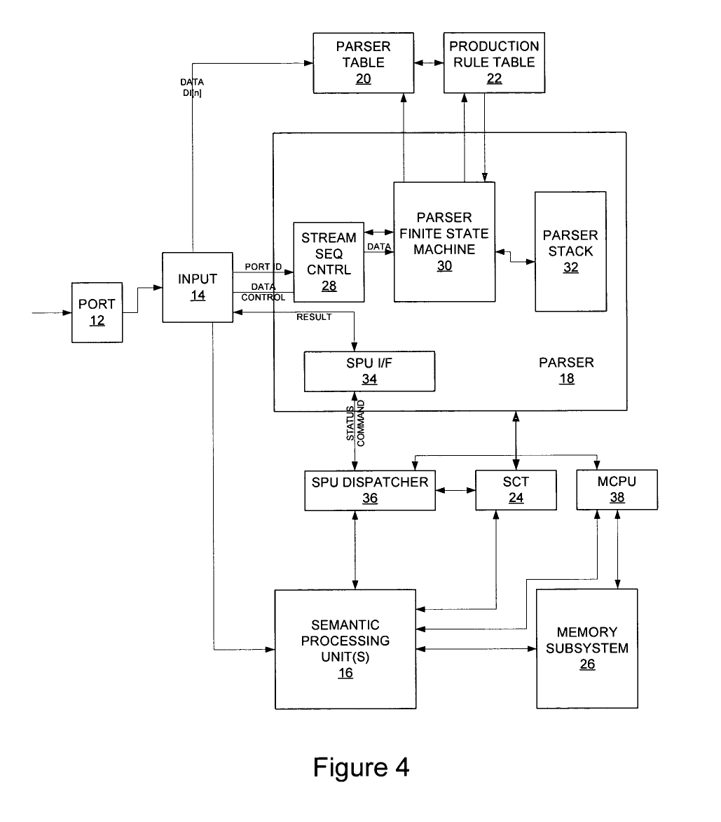

The parser 18 maintains an internal parser stack 32, shown in FIG. 4, of symbols, based on parsing of the current input frame or packet up to the current input symbol. For instance, each symbol on the parser stack 32 is capable of indicating to the parser 18 a parsing state for the current input frame or packet. The symbols are generally non-terminal symbols, although terminal symbols may be in the parser stack as well.

When the symbol or symbols at the top of the parser stack 32 is a terminal symbol, the parser 18 compares data at the head of the input stream to the terminal symbol and expects a match in order to continue. The data is identified as Data In and is generally taken in some portion, such as bytes. Terminal symbols, for example, may be compared against one byte of data, DI. When the symbol at the top of the parser stack 32 is a non-terminal (NT) symbol, parser 18 uses the non-terminal symbol NT and current input data DI detect a match in the production rule code memory 220 and subsequently the product rule table (PRT) 22 which may yield more non-terminal (NT) symbols that expands the grammar production on the stack 32.

In addition, with a non-terminal symbol, as parsing continues, the parser 18 may instruct SPU 16 to process segments of the input stream, or perform other operations. A segment of the input stream may be the next ‘n’ bytes of data, identified as DI[n]. The parser 18 may parse the data in the input stream prior to receiving all of the data to be processed by the semantic processor 10. For instance, when the data is packetized the semantic processor 10 may begin to parse through the headers of the packet before the entire packet is received at input port 12.

Semantic processor 10 generally uses at least three tables. Code segments for SPU 16 are stored in semantic code table (SCT) 24. Complex grammatical production rules are stored in a production rule table (PRT) 22. Production rule (PR) codes for retrieving those production rules are stored in a parser table (PT) 20. The PR codes in parser table 20 also allow parser 18 to detect whether a code segment from semantic code table 24 should be loaded and executed by SPU 16 for a give production rule.

The production rule (PR) codes in parser table 200 point to production rules in production rule table 220. PR codes are stored in some fashion, such as in a row-column format or a content-addressable format. In a row-column format, the rows of the table 20 are indexed by a non-terminal symbol NT on the top of the internal parser stack 32 of FIG. 4, and the columns of the table are indexed by an input data value or values DI at the head of the data input stream in input buffer 12. In a content-addressable format, a concatenation of the non-terminal symbol NT and the input data value or values DI can provide the input to the table 20. Semantic processor 10 will typically implement a content-addressable format, in which parser 18 concatenates the non-terminal symbol NT with 8 bytes of current input data DI to provide the input to the parser table 20. Optionally, parser table 20 concatenates the non-terminal symbol NT and 8 bytes of prior input data DI stored in the parser 18.

It must be noted that some embodiments may include more components than those shown in FIG. 1. However, for discussion purposes and application of the embodiments, those components are peripheral.

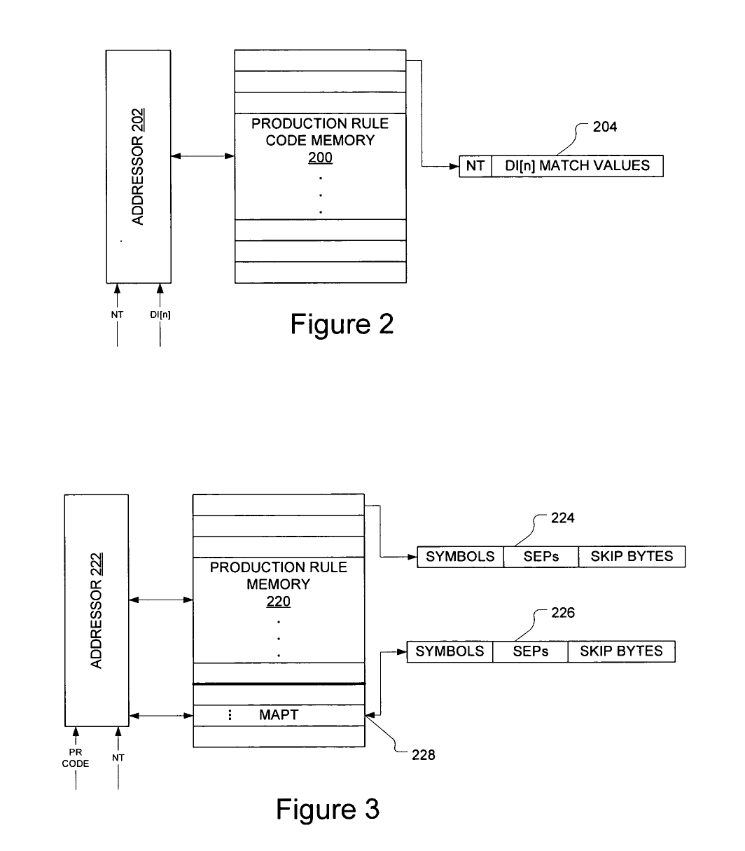

General parser operation for some embodiments will first be explained with reference to FIGS. 1-4. FIG. 2 illustrates one possible implementation of a parser table 20. Parser table 20 is comprised of a production rule (PR) code memory 220. PR code memory 200 contains a plurality of PR codes that are used to access a corresponding production rule stored in the production rule table (PRT) 22. Practically, codes for many different grammars can exist at the same time in production rule code memory 200. Unless required by a particular lookup implementation, the input values as discussed above such as a non-terminal (NT) symbol concatenated with current input values DI[n], where n is a selected match width in bytes need not be assigned in any particular order in PR code memory 200.

In one embodiment, parser table 200 also includes an addressor 202 that receives an NT symbol and data values DI[n] from parser 18 of FIG. 1. Addressor 202 concatenates an NT symbol with the data values DI[n], and applies the concatenated value to PR code memory 200. Optionally, parser 18 concatenates the NT symbol and data values DI[n] prior to transmitting them to parser table 20.

Although conceptually it is often useful to view the structure of production rule code memory 200 as a matrix with one PR code for each unique combination of NT code and data values, there is no limitation implied as to the embodiments of the present invention. Different types of memory and memory organization may be appropriate for different applications.

For example, in one embodiment, the parser table 20 is implemented as a Content Addressable Memory (CAM), where addressor 202 uses an NT code and input data values DI[n] as a key for the CAM to look up the PR code corresponding to a production rule in the PRT 22. Preferably, the CAM is a Ternary CAM (TCAM) populated with TCAM entries. Each TCAM entry comprises an NT code and a DI[n] match value. Each NT code can have multiple TCAM entries. Each bit of the DI[n] match value can be set to “0”, “1”, or “X” (representing “Don't Care”). This capability allows PR codes to require that only certain bits/bytes of DI[n] match a coded pattern in order for parser table 20 to find a match. For instance, one row of the TCAM can contain an NT code NT_IP for an IP destination address field, followed by four bytes representing an IP destination address corresponding to a device incorporating the semantic processor 10. The remaining four bytes of the TCAM row are set to “don't care.” Thus when NT_IP and eight bytes DI[8] are submitted to parser table 20, where the first four bytes of DI[8] contain the correct IP address, a match will occur no matter what the last four bytes of DI[8] contain.

Since, the TCAM employs the “Don't Care” capability and there can be multiple TCAM entries for a single NT, the TCAM can find multiple matching TCAM entries for a given NT code and DI[n] match value. The TCAM prioritizes these matches through its hardware and only outputs the match of the highest priority. Further, when a NT code and a DI[n] match value are submitted to the TCAM, the TCAM attempts to match every TCAM entry with the received NT code and DI[n] match code in parallel. Thus, the TCAM has the ability to determine whether a match was found in parser table 20 in a single clock cycle of semantic processor 10.

Another way of viewing this architecture is as a “variable look-ahead” parser. Although a fixed data input segment, such as eight bytes, is applied to the TCAM, the TCAM coding allows a next production rule to be based on any portion of the current eight bytes of input. If only one bit, or byte, anywhere within the current eight bytes at the head of the input stream, is of interest for the current rule, the TCAM entry can be coded such that the rest are ignored during the match. Essentially, the current “symbol” can be defined for a given production rule as any combination of the 64 bits at the head of the input stream. By intelligent coding, the number of parsing cycles, NT codes, and table entries can generally be reduced for a given parsing task.

The TCAM in parser table 20 produces a PR code corresponding to the TCAM entry 204 matching NT and DI[n], as explained above. The PR code can be sent back to parser 18, directly to PR table 22, or both. In one embodiment, the PR code is the row index of the TCAM entry producing a match.

When no TCAM entry 204 matches NT and DI[n], several options exist. In one embodiment, the PR code is accompanied by a “valid” bit, which remains unset if no TCAM entry matched the current input. In another embodiment, parser table 20 constructs a default PR code corresponding to the NT supplied to the parser table. The use of a valid bit or default PR code will next be explained in conjunction with FIG. 3.

Parser table 20 can be located on or off-chip or both, when parser 18 and SPU 16 are integrated together in a circuit. For instance, static RAM (SRAM) or TCAM located on-chip can serve as parser table 20. Alternately, off-chip DRAM or TCAM storage can store parser table 20, with addressor 202 serving as or communicating with a memory controller for the off-chip memory. In other embodiments, the parser table 20 can be located in off-chip memory, with an on-chip cache capable of holding a section of the parser table 20.

FIG. 3 illustrates one possible implementation for production rule table 22. PR table 22 comprises a production rule memory 220, a Match All Parser entries Table (MAPT) memory 228, and an addressor 222.

In one embodiment, addressor 222 receives PR codes from either parser 18 or parser table 20, and receives NT symbols from parser 18. Preferably, the received NT symbol is the same NT symbol that is sent to parser table 20, where it was used to locate the received PR code. Addressor 222 uses these received PR codes and NT symbols to access corresponding production rules and default production rules, respectively. In one embodiment, the received PR codes address production rules in production rule memory 220 and the received NT codes address default production rules in MAPT 228. Addressor 222 may not be necessary in some implementations, but when used, can be part of parser 18, part of PRT 22, or an intermediate functional block. An addressor may not be needed, for instance, if parser table 20 or parser 18 constructs addresses directly.

Production rule memory 220 stores the production rules 224 containing three data segments. These data segments include: a symbol segment, a SPU entry point (SEP) segment, and a skip bytes segment. These segments can either be fixed length segments or variable length segments that are, preferably, null-terminated. The symbol segment contains terminal and/or non-terminal symbols to be pushed onto the parser stack 32 of FIG. 4. The SEP segment contains SPU entry points (SEP) used by the SPU 16 in processing segments of data. The skip bytes segment contains skip bytes data used by the input buffer 14 to increment its buffer pointer and advance the processing of the input stream. Other information useful in processing production rules can also be stored as part of production rule 224.

MAPT 228 stores default production rules 226, which in this embodiment have the same structure as the PRs in production rule memory 220, and are accessed when a PR code cannot be located during the parser table lookup.

Although production rule memory 220 and MAPT 228 are shown as two separate memory blocks, there is not requirement or limitation to this implementation. In one embodiment, production rule memory 220 and MAPT 228 are implemented as on-chip SRAM, where each production rule and default production rule contains multiple null-terminated segments.

As production rules and default production rules can have various lengths, it is preferable to take an approach that allows easy indexing into their respective memories 220 and 228. In one approach, each PR has a fixed length that can accommodate a fixed maximum number of symbols, SEPs, and auxiliary data such as the skip bytes field. When a given PR does not need the maximum number of symbols or SEPs allowed for, the sequence can be terminated with a NULL symbol or SEP. When a given PR would require more than the maximum number, it can be split into two PRs. These are then accessed such as by having the first issue a skip bytes value of zero and pushing an NT onto the stack that causes the second to be accessed on the following parsing cycle. In this approach, a one-to-one correspondence between TCAM entries and PR table entries can be maintained, such that the row address obtained from the TCAM is also the row address of the corresponding production rule in PR table 22.

The MAPT 228 section of PRT 22 can be similarly indexed, but using NT codes instead of PR codes. For instance, when a valid bit on the PR code is unset, addressor 222 can select as a PR table address the row corresponding to the current NT. For instance, if 256 NTs are allowed, MAPT 228 could contain 256 entries, each indexed to one of the NTs. When parser table 20 has no entry corresponding to a current NT and data input DI[n], the corresponding default production rule from MAPT 228 is accessed.

Taking the IP destination address again as an example, the parser table 20 can be configured to respond to one of two expected destination addresses during the appropriate parsing cycle. For all other destination addresses, no parser table entry would be found. Addressor 222 would then look up the default rule for the current NT, which would direct the parser 18 and/or SPU 16 to flush the current packet as a packet of no interest.

Although the above production rule table indexing approach provides relatively straightforward and rapid rule access, other indexing schemes are possible. For variable-length PR table entries, the PR code could be arithmetically manipulated to determine a production rule's physical memory starting address (this would be possible, for instance, if the production rules were sorted by expanded length, and then PR codes were assigned according to a rule's sorted position). In another approach, an intermediate pointer table can be used to determine the address of the production rule in PRT 22 from the PR code or the default production rule in MAPT 228 from the NT symbol.

FIG. 4 shows one possible block implementation for parser 18. Parser control finite state machine (FSM) 30 controls and sequences overall parser 18 operations, based on inputs from the other logical blocks in FIG. 4. Parser stack 32 stores the symbols to be executed by parser 18. Input stream sequence control 28 retrieves input data values from input buffer 12, to be processed by parser 18. SPU interface 34 dispatches tasks to SPU 16 on behalf of parser 18. The particular functions of these blocks will be further described below.

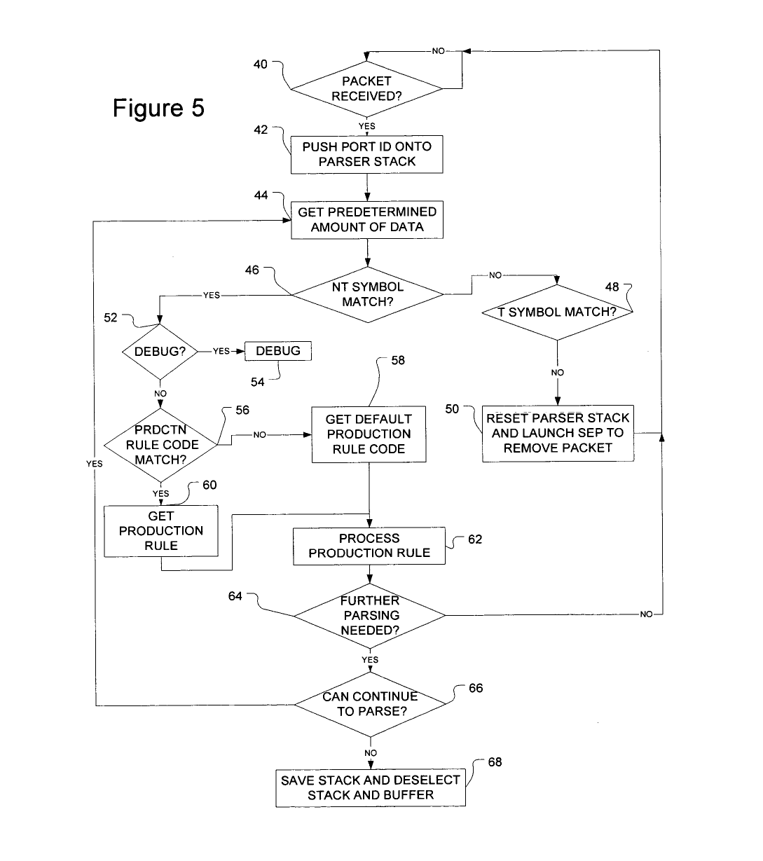

The basic operation of the blocks in FIGS. 1-4 will now be described with reference to the flowchart of an embodiment of data stream parsing in FIG. 5. According to a block 40, semantic processor 10 waits for a packet to be received at input buffer 14 through input port 12.

If a packet has been received at input buffer 14, input buffer 14 sends a Port ID signal to parser 18 to be pushed onto parser stack 32 as a NT symbol at 42. The Port ID signal alerts parser 18 that a packet has arrived at input buffer 14. In one embodiment, the Port ID signal is received by the input stream sequence control 28 and transferred to FSM 30, where it is pushed onto parser stack 32. A 1-bit status flag, preceding or sent in parallel with the Port ID, may denote the Port ID as an NT symbol.

According to a next block 44, parser 18 receives N bytes of input stream data from input buffer 12. This is done, after determining that the symbol on the top of parser stack 32 is not the bottom-of-stack symbol and that the DXP is not waiting for further input. Parser 18 requests and receives the data through a DATA/CONTROL signal coupled between the input stream sequence control 28 and input buffer 12.

At 46, the process determines whether the symbol on the parser stack 32 is a terminal symbol or an NT symbol. This determination may be performed by FSM 30 reading the status flag of the symbol on parser stack 32.

When the symbol is determined to be a terminal symbol at 46, parser 18 checks for a match between the T symbol and the next byte of data from the received N bytes at 48. FSM 30 may check for a match by comparing the next byte of data received by input stream sequence control 28 to the T symbol on parser stack 32. After the check is completed, FSM 30 pops the T symbol off of the parser stack 32, possibly by decrementing the stack pointer.

When a match is not made at 46 or at 48, the remainder of the current data segment may be assumed in some circumstances to be unparseable as there was neither an NT symbol match nor a terminal symbol match. At 50, parser 18 resets parser stack 32 and launches a SEP to remove the remainder of the current packet from the input buffer 14. In one embodiment, FSM 30 resets parser stack 32 by popping off the remaining symbols, or preferably by setting the top-of-stack pointer to point to the bottom-of-stack symbol. Parser 18 launches a SEP by sending a command to SPU 16 through SPU interface 34. This command may require SPU 16 to load microinstructions from SCT 24, that when executed, enable SPU 16 to remove the remainder of the unparseable data segment from the input buffer 14. Execution then returns to block 40.

It is noted that not every instance of unparseable input in the data stream may result in abandoning parsing of the current data segment. For instance, the parser may be configured to handle ordinary header options directly with grammar. Other, less common or difficult header options could be dealt with using a default grammar rule that passes the header options to a SPU for parsing.

Returning to 46, if a match is made execution returns to block 44, where parser 18 requests and receives additional input stream data from input buffer 14. In one embodiment, parser 18 would only request and receive one byte of input stream data after a T symbol match was made, to refill the DI buffer since one input symbol was consumed.

At 50, when the symbol is determined to be an NT symbol, parser 18 sends the NT symbol from parser stack 32 and the received N bytes DI[N] in input stream sequence control 28 to parser table 20, where parser table 20 checks for a match as previously described. In the illustrated embodiment, parser table 20 concatenates the NT symbol and the received N bytes. Optionally, the NT symbol and the received N bytes can be concatenated prior to being sent to parser table 20. The received N bytes are concurrently sent to both SPU interface 34 and parser table 20, and the NT symbol is concurrently sent to both the parser table 20 and the PRT 22. After the check is completed, FSM 30 pops the NT symbol off of the parser stack 32, possibly by decrementing the stack pointer.

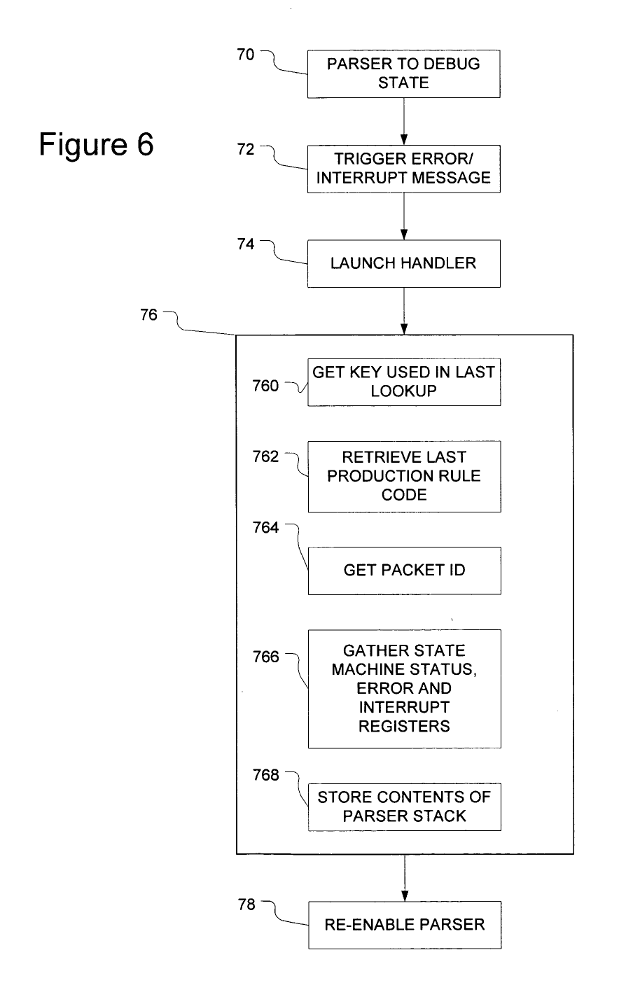

If a match is made at 50, it is determined if the symbol is a debug symbol at 52. If it is a debug symbol at 52, the process moves to a debug process as set out in FIG. 6. If it is not a debug symbol at 52, a production rule code match is determined at 56. This provides a matching production rule from the production rule table 22. Optionally, the PR code is sent from parser table 200 to PRT 250, through parser 18.

If the NT symbol is does not have a production rule code match at 56, parser 18 uses the received NT symbol to look up a default production rule in the PRT 22 at 58. In one embodiment, the default production rule is looked up in the MAPT 228 memory located within PRT 22. Optionally, MAPT 228 memory can be located in a memory block other than PRT 22. In one embodiment, the default production rule may be a debug rule that places the parser in debug mode in recognition of encountering a symbol that has no rule.

In one embodiment, when PRT 22 receives a PR code, it only returns a PR to parser 18 at 60, corresponding either to a found production rule or a default production rule. Optionally, a PR and a default PR can both be returned to parser 18 at 60, with parser 18 determining which will be used.

At 62, parser 18 processes the rule received from PRT 250. The rule received by parser 18 can either be a production rule or a default production rule. In one embodiment, FSM 30 divides the rule into three segments, a symbol segment, SEP segment, and a skip bytes segment. Each segment of the rule may be fixed length or null-terminated to enable easy and accurate division.

In the illustrated embodiment, FSM 30 pushes T and/or NT symbols, contained in the symbol segment of the production rule, onto parser stack 32. FSM 30 sends the SEPs contained in the SEP segment of the production rule to SPU interface 34. Each SEP contains an address to microinstructions located in SCT 24. Upon receipt of the SEPs, SPU interface 34 allocates SPU 16 to fetch and execute the microinstructions pointed to by the SEP. SPU interface 34 also sends the current DI[N] value to SPU 16, as in many situations the task to be completed by the SPU will need no further input data. Optionally, SPU interface 34 fetches the microinstructions to be executed by SPU 16, and sends them to SPU 16 concurrent with its allocation.

FSM 30 sends the skip bytes segment of the production rule to input buffer 14 through input stream sequence control 28. Input buffer 14 uses the skip bytes data to increment its buffer pointer, pointing to a location in the input stream. Each parsing cycle can accordingly consume any number of input symbols between 0 and 8.

After parser 18 processes the rule received from PRT 22, the next symbol on the parser stack 32 is determined to be a bottom-of-stack symbol at 64, or if the parser stack need further parsing. At 64, parser 18 determines whether the input data in the selected buffer is in need of further parsing. In one embodiment, the input data in input buffer 14 is in need of further parsing when the stack pointer for parser stack 32 is pointing to a symbol other than the bottom-of-stack symbol. In some embodiments, FSM 30 receives a stack empty signal SE when the stack pointer for parser stack 32 is pointing to the bottom-of-stack symbol.

When the input data in the selected buffer does not need to be parsed further at 64, typically determined by a particular NT symbol at the top of the parser stack, execution returns to block 40. When the input data in the selected buffer needs to be parsed further, parser 18 determines whether it can continue parsing the input data in the selected buffer at 66. In one embodiment, parsing can halt on input data from a given buffer, while still in need of parsing, for a number of reasons, such as dependency on a pending or executing SPU operation, a lack of input data, other input buffers having priority over parsing, etc. Parser 18 is alerted to SPU processing delays by SEP dispatcher 36 through a Status signal, and is alerted to priority parsing tasks by status values in stored in FSM 30.

When parser 18 can continue parsing in the current parsing context, execution returns to block 44, where parser 18 requests and receives up to N bytes of data from the input data within the selected buffer.

When parser 18 cannot continue parsing at 66, parser 18 saves the selected parser stack and subsequently de-selects the selected parser stack and the selected input buffer at 68. Input stream sequence control 28, after receiving a switch signal from FSM 30, de-selects one input port within 12 by selecting another port within 12 that has received input data. The selected port within 12 and the selected stack within the parser stack 32 can remain active when there is not another port with new data waiting to be parsed.

Having seen the typical parsing operation, it is now possible to see how a NT symbol designating a debug operation may be useful. When parser 18 encounters a debug NT symbol as shown at 54 in FIG. 5, the parser is placed in a debug state. It must be noted that a ‘debug’ symbol may be an explicit debug symbol or a previously unknown symbol in the data being parsed. Both of these will be referred to as a debug symbol. For example, any NT symbol for which there is not a match may place the parser in a debug state. In this last embodiment, the default production rule of FIG. 5 is a debug rule. In either case, the parser is placed in a debug state upon encountering a symbol that is unanticipated or for which there is no rule. The default production rule for the unknown symbol becomes a debug production rule.

In FIG. 6, the parser assumes a debug state at 70. The debug state will trigger an error message, either after the parser assumes the debug state, or simultaneously. The error message may be an interrupt transmitted to the SPU dispatcher indicating that an error condition or interrupt has occurred and a SPU is needed to handle the situation. The dispatcher then launches an SPU to handle the error.

Handling the error may comprise gathering information related to the situation that caused the parser to assume the debug state. This information may include the last key used in looking up the symbol in the CAM, where the key may be the last NT symbol concatenated with the next N bytes of data, as discussed above. The information may also include the last production rule code retrieved prior to this symbol, the packet identifier of the current packet being processed, the status of the FSM, and the status of any error and interrupt registers used in the system. Further, the debug may cause the parser to save the contents of the parser stack for inspection or observation by an SPU.

Once this information is gathered, it is stored, presented to a user, or transmitted back to a manufacturer. For example, if the present parser is operating in a laboratory, it may save an error log for a user to view later, or create an error message on a user display. This would allow programmers at the laboratory to determine what the parser encountered that caused it to enter the debug state, and to provide a rule for that situation in the PRT 22, accessible via a test station to which the parser is attached, such as a computer workstation. Alternatively, the log could be generated by a device operating at a customer site, and the log accessed by a service person during maintenance. In yet another alternative, the log or error message may be transmitted from the customer site back to the manufacturer to allow the manufacturer to remedy the problem.

In this manner, the ability of a manufacturer to identify and expand a grammar used in parsing packets is enhanced. The debug state allows the system to gather data related to a situation that the parser encountered and could not parse. This data can be used to determine if there is a new or previously unknown header that requires a new production rule code to be added to the grammar.

One of ordinary skill in the art will recognize that the concepts taught herein can be tailored to a particular application in many other advantageous ways. In particular, those skilled in the art will recognize that the illustrated embodiments are but one of many alternative implementations that will become apparent upon reading this disclosure.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

What is claimed is:

1. A device, comprising:
at least one input port to allow the processor to receive data;
a parser to:
parse the data in response to symbols in a parser stack;
determine when a symbol is a debug non-terminal symbol; and
notify the device of an interrupt.

2. The device of claim 1, the device further comprising an array of semantic processing units.

3. The device of claim 2, the device further comprising a dispatcher to receive the notification of the interrupt and to dispatch the interrupt to one of the array of semantic processing units to handle the interrupt.

4. The device of claim 3, the semantic processing unit further to gather data related to the interrupt and store it.

5. The device of claim 4, the semantic processing unit to gather data further comprising a semantic processing unit to determine at least one of the group consisting of: the last data, a packet identifier from which the data was accessed, a last state in the parser finite state machine, and last contents of the parser stack.

6. The device of claim 1, the device further comprising an output port to allow the device to communicate the interrupt externally.

7. The device of claim 6, the output port further comprising an output port to a controller.

8. The device of claim 6, the output further comprising an output port to a network.

9. A method of processing data, comprising:
accessing a predetermined amount of data by a device having a parser;
determine if there is a match for the predetermined amount of data in a parser stack;
if there is no match, placing the device in a debug state; and
gathering information as to the status of the device at the time the predetermined amount of data was accessed.

10. The method of claim 9, the method further comprising triggering a message having the information as to the status of the device to a controller.

11. The method of claim 10, triggering a message further comprising triggering an error message to a user.

12. The method of claim 10, triggering a message further comprising triggering an error message to be written and stored.

13. The method of claim 10, triggering a message further comprising triggering a message to be sent externally from a customer site.

14. The method of claim 9, determining if there is a match for the predetermined amount of data further comprising determining that the symbol is a non-terminal symbol.

15. The method of claim 9, determining if there is a match for the predetermined amount of data further comprising looking up the predetermined amount of data in a table.

16. The method of claim 9, placing the device in a debug state further comprising:
generating an interrupt;
transmitting the interrupt to a dispatcher; and
assigning a semantic processing unit to handle the interrupt.

17. The method of claim 9, gathering information as to the status of the device at the time the predetermined data was accessed further comprising recording at least one of the group consisting of: last data, a last state of the parser finite state machine, a packet identifier from which the data was accessed, and last contents of the parser stack.
